(19) United States
(12) Patent Application Publication
(10) Pub. No.: US 2010/0033293 A1
(43) Pub. Date: Feb. 11, 2010

(54) FUSE ASSEMBLY WITH A CAPABILITY OF INDICATING A FUSING STATE BY LIGHT

(76) Inventors: Wen-Tsung CHENG, Taoyuan (TW); Wen-Ho CHENG, Taoyuan (TW)

Correspondence Address: HDLS Patent & Trademark Services, P.O. BOX 220746, CHANTILLY, VA, 20153-0746, US

(21) Appl. No.: 12/186,666

(22) Filed: Aug. 6, 2008

(51) Int. Cl. H01H 85/30

(52) U.S. Cl. 337/241

(57) ABSTRACT

A fuse capable of indicating whether the fuse is blown or not includes a fuse body formed therein with an accommodating space. The accommodating space is provided with two electrical-conductive terminals connected to each other via a metallic fuse. A light-emitting diode is inserted into the accommodating hole of the fuse body, thereby electrically connecting two electrodes of the light-emitting diode to the two electrical-conductive terminals. Via the above arrangement, the light-emitting diode can be lighted up when the fuse body is blown.

### BACKGROUND OF THE INVENTION

1. Field of the Invention

The present invention relates to a fuse, and in particular to a fuse capable of indicating a state.

2. Description of Prior Art

The fuse is an over-current protection device that is widely used in electronic products or circuits. When the electronic product suffers damage or the circuit is in an abnormal state, the current will rise instantaneously. When the flowing current exceeds the maximum of the fuse, the fuse will be blown, thereby preventing the excessive current from damaging the electronic elements within the electronic product. Therefore, the fuse can protect the electronic product and can be used to check a circuit.

In practice, the fuse is not singly used. A car or a large-scale power-distributing apparatus is provided with rows of fuses, thereby protecting the electronic elements against an over-current respectively. However, when one of the fuses is blown or needs to be replaced or checked, the operator has to check the rows of fuses one by one, which causes a lot of disturbance in use.

Therefore, a fuse assembly combined with a light-emitting body is proposed. The casing of the fuse assembly is provided therein with a light-emitting body. Specifically, the light-emitting body is disposed between two metallic electrical-conductive pieces and in parallel to the fuse. In a normal state, the current only flows through the fuse, so that the light-emitting body does not illuminate. When the fuse is blown due to an over-current, the current will flow through the light-emitting body, so that the light-emitting body illuminates to indicate the blowing of the fuse. Thus, it is convenient for the operator to check and replace the damaged fuses.

However, in practice, the above-mentioned fuse assembly still has some drawbacks as follows. Since the light-emitting body is inserted and accommodated in the casing of the fuse assembly, when a fuse is blown, the light-emitting body is thrown away together with the damaged fuse, which causes the waste of materials and money. Especially, in order to conform to the requirement for environmental protection, it is necessary to improve such a fuse assembly. On the other hand, the manufacturing procedure of combining a fuse assembly with a light-emitting body is complicated. Also, the cost of assembling is larger.

Therefore, it is an important issue for the present Inventor to overcome the above problems.

### SUMMARY OF THE INVENTION

The present invention is to provide a fuse assembly with a capability of indicating a fusing state by light, thereby recycling light-emitting diodes to reduce the cost and conforming to the requirement for environmental protection.

The present invention is to provide a fuse assembly with a capability of indicating a fusing state by light, whereby the manufacturing process can be simplified to reduce the manufacturing and assembling cost.

The present invention is to provide a fuse assembly with a capability of indicating a fusing state by light, which includes a fuse body formed therein with an accommodating space, a side surface of the fuse body being provided with an accommodating hole; two electrical-conductive terminals accommodated in the accommodating space of the fuse body; and a light-emitting diode inserted into the accommodating hole of the fuse body, thereby electrically connecting the light-emitting diode to the two electrical-conductive terminals. Via the above arrangement, the light-emitting diode can be lighted up when the fuse body is blown.

### BRIEF DESCRIPTION OF THE DRAWINGS

FIG. 1 is an assembled perspective view showing an embodiment of the present invention;

FIG. 2 is a perspective view showing the external appearance of an embodiment of the present invention;

FIG. 3 is an assembled cross-sectional view showing an embodiment of the present invention;

FIG. 4 is an assembled cross-sectional view showing another side of an embodiment of the present invention;

FIG. 5 is a schematic view showing the operating state of an embodiment of the present invention;

FIG. 6 is an assembled cross-sectional view showing a second embodiment of the present invention; and

FIG. 7 is an assembled cross-sectional view showing a third embodiment of the present invention.

### DETAILED DESCRIPTION OF THE INVENTION

The detailed description and technical contents of the present invention will be explained with reference to the accompanying drawings. However, the drawings are illustrative only but not used to limit the present invention.

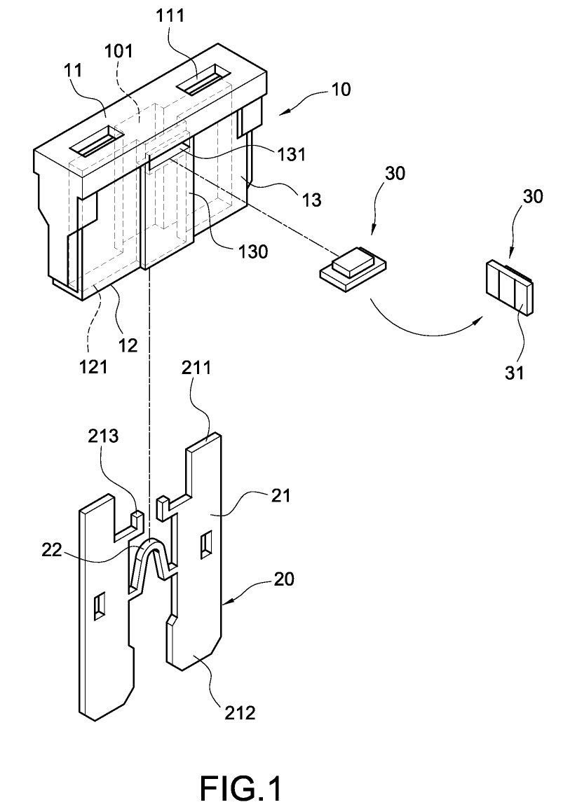

Please refer to FIG. 1 first, which is an assembled perspective view of the present invention. The present invention provides a fuse assembly with a capability of indicating a fusing state by light, which includes a fuse body 10. The top surface 11 of the fuse body 10 is provided with two troughs 111 arranged in a straight line. The bottom surface 12 thereof is provided with an open trough 121. The side surface 13 of the fuse body 10 is formed into a convex surface 130, on which an accommodating hole 131 is provided. In addition, the interior of the fuse body 10 is formed with an accommodating space 101 in communication with the two troughs 111, the open trough 121 and the accommodating hole 131. The accommodating space 101 of the fuse body 10 accommodates a metallic piece 20. The metallic piece 20 includes two electrical-conductive terminals 21. The two electrical-conductive terminals 21 are connected with each other via a metallic fuse 22. The side surfaces of the two electrical-conductive terminals 21 are formed with elastic contacting arms 213 above the metallic fuse 22 respectively. The top ends 211 of the two electrical-conductive terminals 21 are inserted into the two troughs 111 of the fuse body 10. Pins 212 of the two electrical-conductive terminals 21 penetrate the open trough 121 of the fuse body 10. The accommodating hole 131 of the fuse body 10 is provided therein with a light-emitting diode 30, so that an electrical-conductive surface 31 of the light-emitting diode 30 is brought into contact with the two contacting arms 213 of the metallic piece 20. In this way, the two electrodes of the light-emitting diodes 30 can be electrically connected with the two electrical-conductive terminals 21.

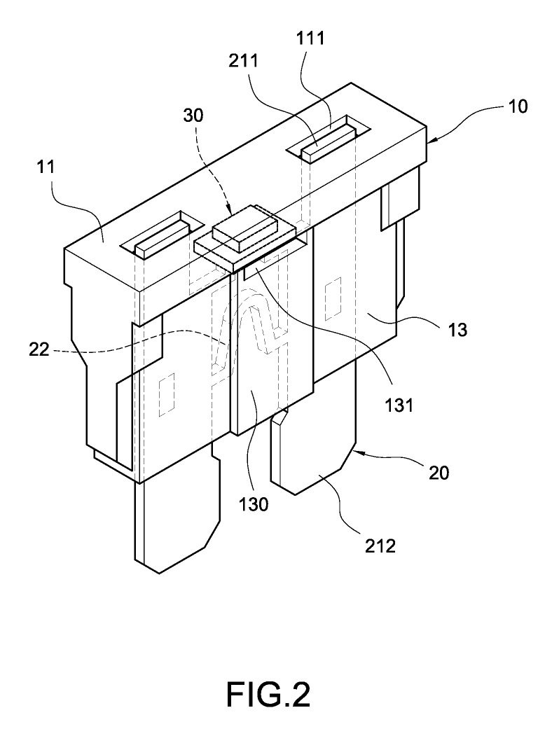

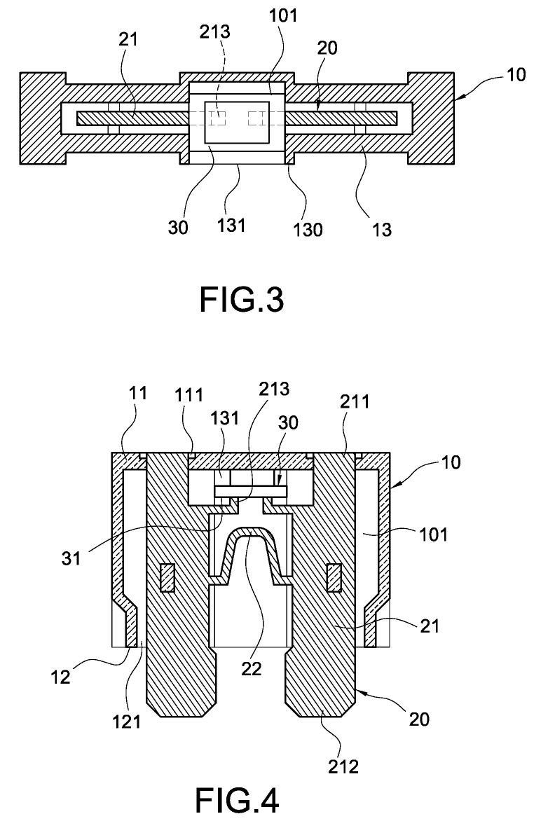

Please refer to FIGS. 2 to 4. FIG. 2 is a perspective view showing the external appearance of the present invention, FIG. 3 is an assembled cross-sectional view, and FIG. 4 is an assembled cross-sectional view showing another side of the present invention. The metallic piece 20 is inserted into the accommodating space 101 of the fuse body 10 with the top ends 211 of its two electrical-conductive terminals 21 being inserted into the two troughs 111 of the fuse body 10. The pins 212 of the two electrical-conductive terminals 21 penetrate the bottom surface 12 of the fuse body 10. The light-emitting diode 30 is disposed on the contacting arms 213 of the two electrical-conductive terminals 21 via the accommodating hole 131 of the fuse body 10, thereby electrically connecting the two electrodes on an electrical-conductive surface 31 of the light-emitting diode 30 to the two electrical-conductive terminals 21. Since the two contacting arms 213 are elastic, when the light-emitting diode 30 is disposed in the accommodating hole 131, the two contacting arms 213 can be bent slightly to sandwich the light-emitting diode 30 between the top surface 11 of the fuse body 10 and the contacting arms 213. In this way, the top surface of the light-emitting diode 30 can exactly abut the underside of the top surface 11 of the fuse body 10 without falling down, so that the light-emitting diode 30 can be inserted into or pulled out of the accommodating hole 131 of the fuse body 10. Furthermore, after the light-emitting diode 10 is disposed in the accommodating hole 131, the side surface of the light-emitting diode 30 is located below or in flush with the convex surface 131 of the side surface 13 of the fuse body 10.

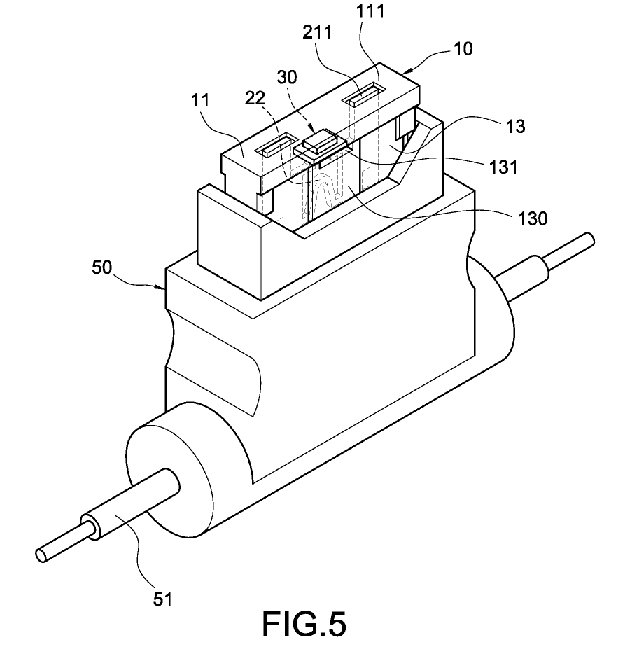

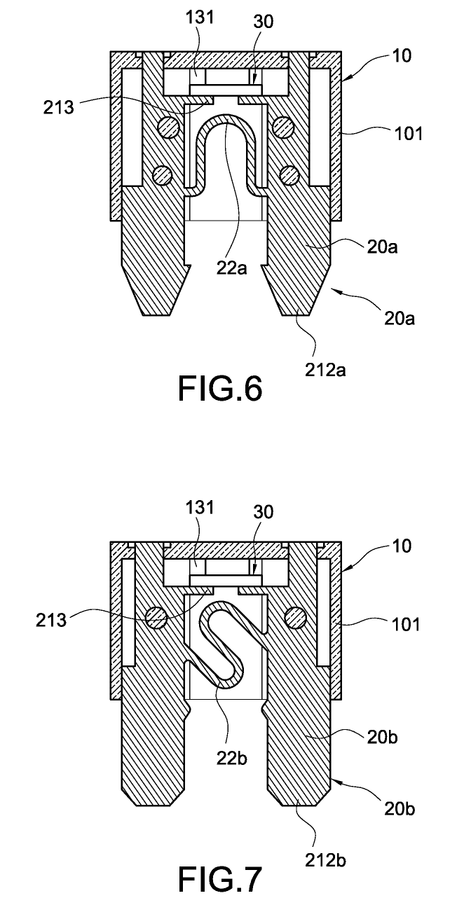

Please refer to FIG. 5, which is a schematic view showing the operating state of the fuse assembly with a capability of indicating a fusing state by light according to the present invention. In use, the fuse is inserted into a fuse base 50. The interior of the fuse base 50 is provided with electrical-conductive pieces (not shown). After the fuse is inserted into the fuse base 50, the electrical-conductive pieces are electrically connected to the pins 212 of the two electrical-conductive terminals 21 of the fuse (FIG. 1). Both sides of the fuse base 50 are provided with a power line 51 respectively. After the power source is connected, in a normal state, the current will pass through the metallic fuse 22 of the fuse body. Therefore, in the normal state, the light-emitting diode 30 does not illuminate. When the electrical product suffers damage or the circuit is in an abnormal state, the instantaneously-rising current will blow the metallic fuse 22. After the metallic fuse 22 is blown, the current will pass through the light-emitting diode 30 and thus the light-emitting diode is lighted up. The light emitted by the light-emitting diode 30 pierces the fuse body 10, thereby indicating the blowing of the fuse. Therefore, it is convenient for an operator to replace and check the damaged fuse. Please refer to FIGS. 6 and 7. FIG. 6 and FIG. 7 show the second and the third embodiments of the fuse assembly with a capability of indicating a fusing state by light according to the present invention respectively. The second and third embodiments are substantially identical to the first embodiment, and the light-emitting diode 30 is inserted into the accommodating hole 131 of the fuse body 10. The difference between these two embodiments and the first embodiment lies in the metallic pieces 20a, 20b inserted into the accommodating space 101 of the fuse body 10. The metallic pieces 20a, 20b consist of two electrical-conductive terminals 21a, 21b. The pins 212a, 212b of the two electrical-conductive terminals 21a, 21b and the metallic fuses 22a, 22b are slightly different from those of the first embodiment in their forms. However, each of these three embodiments has the same capability of indicating a fusing state.

Therefore, according to the present invention, after the fuse is blown, the light-emitting diode 30 can be taken out of the accommodating hole 131 of the fuse body 10, thereby recycling the light-emitting diode 30 to reduce the cost and conform to the requirement for environmental protection. Furthermore, the assembling procedure of the light-emitting diode 30 is simple, so that the manufacturing procedure of the present invention is also simplified and the manufacture cost is reduced. Therefore, the present invention has a great practicability and is economic-effective.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A fuse assembly with a capability of indicating a fusing state by light, comprising;
a fuse body formed therein with an accommodating space, a side surface of the fuse body being provided with an accommodating hole;
two electrical-conductive terminals accommodated in the accommodating space of the fuse body; and
a light-emitting diode inserted into the accommodating hole of the fuse body, thereby electrically connecting the light-emitting diode to the two electrical-conductive terminals.

2. The fuse assembly with a capability of indicating a fusing state by light according to claim 1, wherein the top surface of the fuse body is provided with two troughs, the bottom surface of the fuse body is provided with an open trough, the accommodating space is in communication with the two troughs, the open trough and the accommodating hole.

3. The fuse assembly with a capability of indicating a fusing state by light according to claim 2, wherein the two troughs of the fuse body are arranged in a straight line.

4. The fuse assembly with a capability of indicating a fusing state by light according to claim 1, wherein the two electrical-conductive terminals are made of a metallic piece, the two electrical-conductive terminals are connected to each other via a metallic fuse and pass through the open trough of the fuse body.

5. The fuse assembly with a capability of indicating a fusing state by light according to claim 1, wherein the side surface of the fuse body is formed with a convex surface, and the convex surface is provided with the accommodating hole.

6. The fuse assembly with a capability of indicating a fusing state by light according to claim 1, wherein the side surfaces of the two electrical-conductive terminals are formed with an elastic contacting arm respectively.

7. The fuse assembly with a capability of indicating a fusing state by light according to claim 6, wherein the light-emitting diode is sandwiched between the top surface of the fuse body and the two contacting arms.

8. The fuse assembly with a capability of indicating a fusing state by light according to claim 7, wherein the top surface of the light-emitting diode abuts the underside of the top surface of the fuse body.
